(19) United States
(12) Patent Application Publication
(10) Pub. No.: US 2026/0316670 A1
(43) Pub. Date: Oct. 15, 2026

(54) VEHICLE NON-POLARIZED INPUT SWITCHING CIRCUIT

(71) Applicant: ESUSE AUTO PARTS MANUFACTURING CO., LTD., New Taipei (TW)

(72) Inventors: Ting-Fang LEE, New Taipei (TW); Wen-Chung HAN, New Taipei (TW)

(21) Appl. No.: 19/556,744

(22) Filed: Mar. 4, 2026

Related U.S. Application Data
(63) Continuation-in-part of application No. 18/663,428, filed on May 14, 2024, now Pat. No. 12,588,128.

(51) Int. Cl. B60Q 1/46; H05B 47/17

(52) U.S. Cl. CPC B60Q 1/46; H05B 47/17

(57) ABSTRACT

A vehicle non-polarized input switching circuit, which includes a control signal source, active switches coupled to the control signal source, multiple current limiters coupled between drains of the active switches and the control signal source to limit current in the reverse direction to the current limiters and prevent the active switches from being turned on by mistake. Through the setting of multiple current limiters, a signal processor can sense the trigger signal of positive voltage, negative voltage, or ground voltage of a vehicle battery of a vehicle power supply and drive a plurality of warning lights to flash, achieving a simple and quick setting function (for example: flashing modes of the plurality of warning lights, a polling flash, a recursive flash, a low power mode or a sleep mode, automatic identity switching and other functions) to avoid malfunctions caused by incorrect polarity judgment.

### CROSS REFERENCE TO THE RELATED APPLICATIONS

This application is a Continuation-In-Part of Application No. Ser. No. 18/663,428, filed on May 14, 2024, for which priority is claimed under 35 U.S.C. § 120, the entire contents of which are hereby incorporated by reference.

### BACKGROUND OF THE INVENTION

### 1. Field of the Invention

The present invention relates to a vehicle non-polarized input switching circuit, specifically designed for situations where conventional warning lights have a fixed flashing mode that cannot be changed. This invention achieves easy and quick switching functions of warning lights (e.g., flashing mode) by switching between a synchronous flash, an interlaced flash, or other flash modes (e.g., a polling flash, a recursive flash, a low power mode, or a sleep mode) through a non-polarized input (positive voltage, negative voltage, or ground voltage of a vehicle battery), and avoids malfunctions caused by incorrect polarity judgment.

### 2. Description of the Related Art

Warning lights are used in many environments and places, such as road construction warnings, public place safety warnings, high-rise building safety warnings, fire trucks, ambulances and police vehicles, etc. The warning lights can be divided into a single warning light or a light device composed of multiple warning lights, and the light device is mostly installed on the roof of the aforementioned vehicles that require warning. Conventional light devices require the addition of an electronic control device (for example: electronically erasable, programmable, read-only memory [EEPROM]) to manage multiple warning lights in order to achieve a coordinated warning effect when multiple warning lights flash. Currently, almost all commercially available warning lights have the same appearance and flashing effect. However, the flashing effect of multiple warning lights controlled by an electronic control device is not very coordinated, and the flashing mode is fixed and cannot be changed, which also results in poor warning effect. Furthermore, the additional electronic control devices added to commercially available warning lights increase manufacturing costs, thereby raising the final selling price of the light devices and hindering their price competitiveness in the market. The aforementioned shortcomings of commercially available light devices need to be addressed by those in the industry.

In addition, when general vehicle repair and maintenance shops install light devices in vehicles, maintenance personnel who are not familiar with the light device wiring often cannot correctly connect them to the vehicle power supply, causing the light devices to malfunction. Furthermore, in the environment where a large number of light devices need to be installed in a vehicle, the maintenance personnel still need to spend a lot of time identifying the color of the insulation of the light device wiring in order to match and assemble them one by one, which is too time-consuming and labor-intensive for assembly. Therefore, simplifying the process of installing light devices in vehicles has become a topic that those in this industry urgently need to study.

### SUMMARY OF THE INVENTION

Therefore, in view of the above problems and deficiencies, the inventor collected relevant information, and after multiple evaluations and considerations, designed the invention of this vehicle non-polarized input switching circuit.

The main object of the present invention is to provide a vehicle non-polarized input switching circuit, which comprises a signal processor (12) internally storing data for multiple flash modes (121); a warning light control IC (13) coupled to a plurality of warning lights (11a~11n) installed on a vehicle and also coupled to the signal processor (12); and a control circuit (23) comprising at least one control signal source (231) capable of performing automatic identity switching (AUTO ID). The at least one control signal source (231) each is coupled to a second active switch (Q1). The second active switch (Q1) has an output terminal thereof coupled to a control input side (123) of the signal processor (12). The at least one control signal source (231) and the second active switch (Q1) have a second current limiter (D1) and two resistors ([R1, R4]) connected in series therebetween. The two resistors ([R1, R4]) have pins thereof coupled to ground. The two resistors ([R1, R4]) have a first node (n1) therebetween coupled to a gate (G) of the second active switch (Q1). The second active switch (Q1) has a source (S) thereof coupled to ground and has a drain (D) thereof coupled to the control input side (123) of the signal processor (12). The drain (D) of the second active switch (Q1) coupled to the at least one control signal source (231) by a third current limiter (D8) that limits current in the reverse direction to the second current limiter (D1) and prevents the second active switch (Q1) from being accidentally turned on, wherein by setting the second current limiter (D1) and the third current limiter (D8), the signal processor (12) is capable of switching the flash modes (121) from a first mode to a second mode when sensing positive voltage (+V_{CARBAT}), negative voltage (−V_{CARBAT}), or ground voltage (V_{GND}) of a vehicle battery of a vehicle power supply (232). By setting the aforementioned multiple current limiters, the signal processor (12) can sense trigger signals of the positive voltage (+V_{CARBAT}), the negative voltage (−V_{CARBAT}), or the ground voltage (V_{GND}) of the vehicle battery of the vehicle power supply (232), and drive the plurality of warning lights (11a~11n) to flash. This allows maintenance personnel unfamiliar with light device wiring and vehicle power supply assembly to perform one-by-one matching and assembly without needing to identify the color of the light device wiring insulation, thus simplifying the process of installing the light device (1) in the vehicle and saving assembly time and manpower. Furthermore, since the conventional flashing mode of warning lights is a fixed input method that cannot be changed, this invention achieves the purpose of easily and quickly switching the flashing mode of warning lights by switching between synchronous flash (1211), interlaced flash (1212), or other flash modes (121) (e.g., polling flash (1213), recursive flash (1214), a low power mode (1215), or a sleep mode (1216)) through a non-polar input (the positive voltage (+V_{CARBAT}), the negative voltage (−V_{CARBAT}), or the ground voltage (V_{GND}) of the vehicle battery).

Another object of the present invention is that the at least one control signal source (231) further comprises a power on/off signal (POWER ON/OFF) and a switch pattern signal (SWITCH PATTERN), and the power on/off signal (POWER ON/OFF) and the switch pattern signal (SWITCH PATTERN) are respectively coupled to a third active switch (Q3) or a fourth active switch (Q5) to form a coupling. An output terminal of the third active switch (Q3) or the fourth active switch (Q5) are coupled to the control input side (123) of the signal processor (12). The at least one control signal source (231) is connected in series with the third active switch (Q3) or the fourth active switch (Q5) by a fourth current limiter (D4) or a fifth current limiter (D5) and two resistors ([R6, R8] or [R10, R13]). The two resistors ([R6, R8] or [R10, R13]) connected in series have pins thereof coupled to ground. A first node (n1) between the two resistors ([R6, R8] or [R10, R13]) is coupled to a gate (G) of the third active switch (Q3) or the fourth active switch (Q5), a source(S) of the third active switch (Q3) or the fourth active switch (Q5) is coupled to ground, and a drain (D) of the third active switch (Q3) or the fourth active switch (Q5) are coupled to the control input side (123) of the signal processor (12).

Still another object of the present invention is that a first current-limiting resistor (R20) is connected in series between a signal processor power supply (MCUVCC) and the drain (D) of the second active switch (Q1); a second current-limiting resistor (R21) is connected in series between the signal processor power supply (MCUVCC) and the drain (D) of the third active switch (Q3); a third current-limiting resistor (R22) is connected in series between the signal processor power supply (MCUVCC) and the drain (D) of the fourth active switch (Q5).

Still another object of the present invention is that a first Zener diode (ZD1) is coupled between an output terminal of the second current limiter (D1) and the gate (G) of the second active switch (Q1); a second Zener diode (ZD2) is coupled between an output terminal of the fourth current limiter (D4) and the gate (G) of the third active switch (Q3) and a third Zener diode (ZD3) is coupled between an output terminal of the fifth current limiter (D5) and the gate (G) of the fourth active switch (Q5), and the breakdown voltage of the first, second and third Zener diodes (ZD1, ZD2 and ZD3) is greater than or equal to the voltage provided by the signal processor power supply (MCUVCC).

Still another object of the present invention is that the first mode and the second mode of the flash modes (121) are selectively the synchronous flash (1211), the interlaced flash (1212), the polling flash (1213), a recursive flash (1214), the low power mode (1215), or the sleep mode (1216).

### BRIEF DESCRIPTION OF THE DRAWINGS

FIG. 1 is a functional block diagram of the light device and its control architecture of the present invention.

FIG. 2 is a functional block diagram of the data stored inside the signal processor of the present invention.

FIG. 3 is another functional block diagram of the light device and its control architecture of the present invention.

FIG. 4 is a schematic diagram of the light device and its wiring coupling of the present invention.

FIG. 5 is a circuit diagram of one single warning light of the present invention.

### DETAILED DESCRIPTION OF THE PREFERRED EMBODIMENT

In order to achieve the above-mentioned objects and effects, the technical means and structure adopted by the present invention are described in detail with reference to the preferred embodiment of the present invention, and its features and functions are as follows, so as to facilitate a complete understanding.

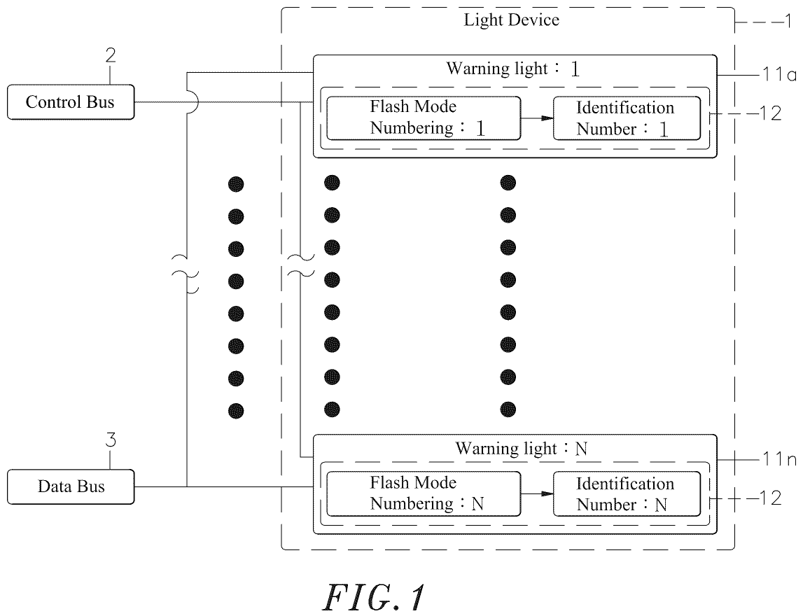

Please refer to FIGS. 1 to 3, which are functional block diagram of the light device and its control architecture of the present invention, functional block diagram of the data stored inside the signal processor of the present invention and another functional block diagram of the light device and its control architecture of the present invention.

As can be clearly seen from the figures, the control circuit of the present invention applied to warning lights comprises: a light device (1), a control bus (2) and a data bus (3). Its main components and features are described in detail below:

Please refer to FIG. 1, where the light device (1) comprises a plurality of warning lights (11a~11n), and the plurality of warning lights (11a~11n) are respectively coupled to the control bus (2) and the data bus (3) via a respective signal line. The plurality of warning lights (11a~11n) each comprise a signal processor (12) therein, which is composed of a microcontroller unit (MCU), a central processing unit (CPU), or a general purpose input/output (GPIO).

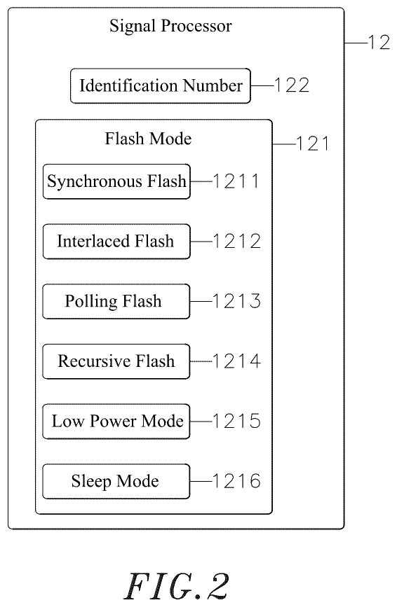

Please refer to FIG. 2, where the signal processor (12) of each of the plurality of warning lights (11a~11n) stores a flash mode (121) and an identification number (122). A first mode and a second mode of the flash mode (121) selectively a synchronous flash (1211), an interlaced flash (1212), a polling flash (1213), a recursive flash (1214), a low power mode (1215), or a sleep mode (1216). In addition to the aforementioned flash mode (121), a starter (4) can also control multiple receivers (5) to flash in different modes via the data bus (3) (e.g., a first receiver performs the synchronous flash (1211), a second receiver performs the polling flash (1213), and a third receiver performs the interlaced flash (1212)). The aforementioned control of multiple receivers (5) by the starter (4) is also within the scope of protection of this invention. The identification number (122) is determined based on a start command signal (21) and a change of identity command signal (22) of the control bus (2). Therefore, the identification number (122) of the plurality of warning lights (11a~11n) is in a floating state, but it can only be changed by receiving the aforementioned start command signal (21) and change of identity command signal (22).

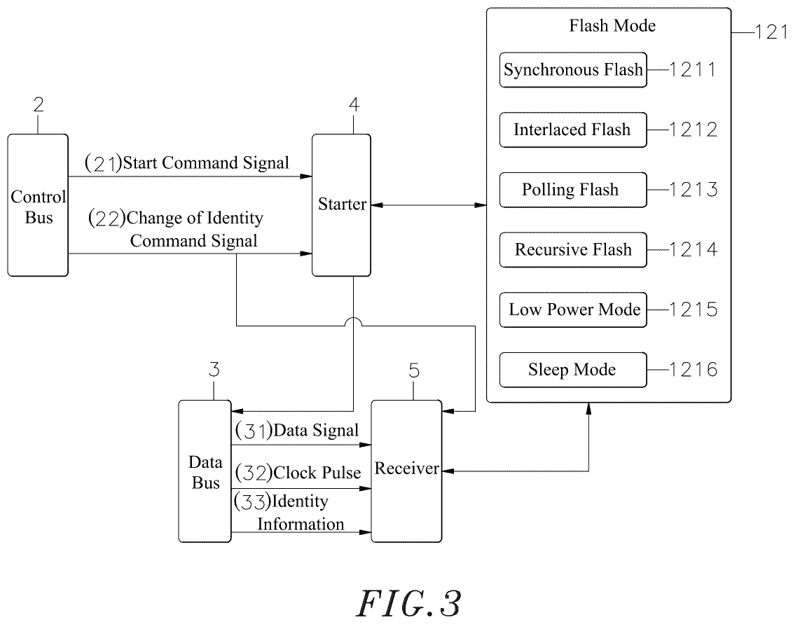

Please refer to FIG. 3, where the control bus (2) sends the start command signal (21) to notify the plurality of warning lights (11a~11n), sets the flash mode (121), and sequentially numbers each of the plurality of warning lights (11a~11n) starting from 1. The flash mode (121) numbering is used to synchronously set the identification number (122) of each of the plurality of warning lights (11a~11n). Set a predetermined identification number of the plurality of warning lights (11a~11n) to be the starter (4), and set the remaining identification numbers to be the receivers (5). The warning light, which is set as the starter (4), receives the start command signal (21) through the control bus (2) and transmits a data signal (31), a clock pulse (32) and an identity information (33) from the data bus (3), and the flash mode (121) selects one of the following (the synchronous flash (1211), the interlaced flash (1212), the polling flash (1213), the recursive flash (1214), the low power mode (1215), or the sleep mode (1216)) to perform light flashing. The warning lights, which are set as the receivers (5), obtain the data signal (31), the clock pulse (32) and the identity information (33) through the data bus (3), and the receivers (5) and the starter (4) flash in the flash mode (121) in synchronous, asynchronous, the low power mode (1215), or sleep mode (1216).

In the above-mentioned plurality of warning lights (11a~11n) synchronously setting the identification number (122) of each of the plurality of warning lights (11a~11n) through the flash mode (121) numbering, under normal circumstances, the one with the identification number 1 can be set as the starter (4), but this invention is not self-limiting. Each identification number (122) can potentially act as the starter (4) through the control bus (2) configuration. For example, identification numbers such as 2, 5, 8, etc., which are not number 1, may also be selectively used as the starter (4). This mode, which uses the control bus (2) to set any identification number (122) of the plurality of warning lights (11a~11n) as the starter (4), is also protected by this invention.

During the process of the starter (4) and the receivers (5) performing synchronous or asynchronous light flashing, if the change of identity command signal (22) is received from the common control bus (2), then the identity change of the starter (4) and the receivers (5) is performed. The specific procedure is that before the starter (4) and the receivers (5) change their identities, the receivers (5) first pause the current flash mode (121) and then execute a self-flash mode. The control bus (2) will send out the start command signal (21) to notify the plurality of warning lights (11a~11n), set the flash mode (121), and sequentially number each of the plurality of warning lights (11a~11n) starting from 1. The flash mode (121) numbering is used to synchronously set the identification number (122) of each of the plurality of warning lights (11a~11n).

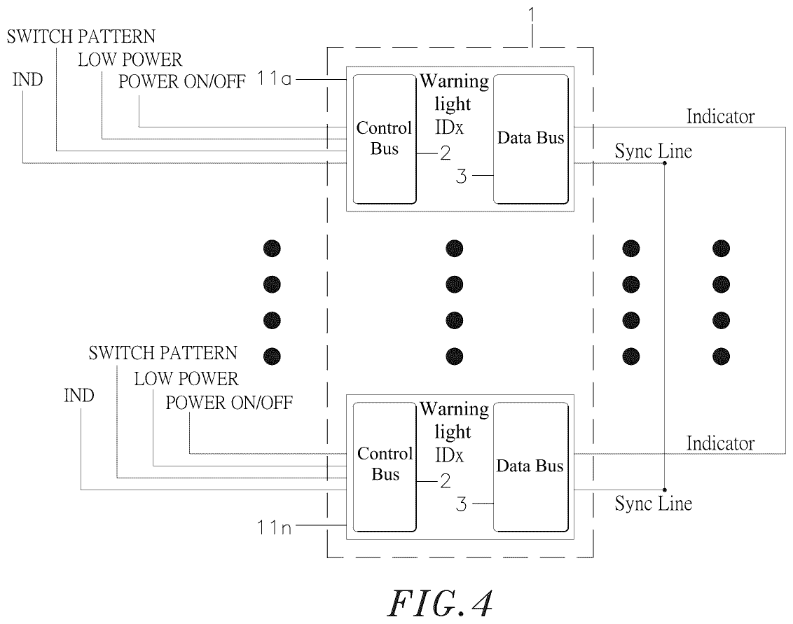

Please refer to FIGS. 3, 4 and 5. The signal processor (12) stores data of multiple flash modes (121). It uses the flash mode (121) numbering to synchronously set the identification number (122) of each of the plurality of warning lights (11a~11n). The predetermined identification number of the plurality of warning lights (11a~11n) is set as the starter (4), and the remaining identification numbers are set as the receivers (5).

A warning light control IC (13) is coupled to the plurality of warning lights (11a~11n) and is also coupled to the signal processor (12) via a data output side (125) and the data bus (3). A flash activation preventive circuit (35) is provided between the warning light control IC (13) and the data bus (3). The flash activation preventive circuit (35) comprises a first active switch (Q6), a first current limiter (D6), a first shunt resistor (R18) and a second shunt resistor (R19). A gate (G) of the first active switch (Q6) is coupled between the first and second shunt resistors (R18 and R19), an opposite end of the first shunt resistor (R18) is coupled to an input voltage source (VIN), and an opposite end of the second shunt resistor (R19) is coupled to ground. A source(S) of the first active switch (Q6) is coupled to ground. A drain (D) of the first active switch (Q6) is coupled to the positive (+) terminal of the first current limiter (D6), and the negative (−) terminal of the first current limiter (D6) is coupled to the data bus (3). When a warning light control circuit is activated, the activation pulse of the data bus (3) is blocked by the first current limiter (D6) and will not cause the warning light control IC (13) to be momentarily activated.

A control circuit (23) comprising at least one control signal source (231) capable of performing automatic identity switching (AUTO ID) is provided. The control signal source (231) is coupled to a second active switch (Q1), and an output terminal of the second active switch (Q1) is coupled to a control input side (123) of the signal processor (12). A second current limiter (D1) and two resistors ([R1, R4]) are connected in series between the control signal source (231) and the second active switch (Q1), and pins of the two resistors ([R1, R4]) connected in series are coupled to ground. Furthermore, a first node (n1) between the two resistors ([R1, R4]) is coupled to a gate (G) of the second active switch (Q1), a source(S) of the second active switch (Q1) is coupled to ground, and a drain (D) of the second active switch (Q1) is coupled to the control input side (123) of the signal processor (12). The drain (D) of the second active switch (Q1) is coupled to the control signal source (231) by a third current limiter (D8) that limits current in the reverse direction to the second current limiter (D1) and prevents the second active switch (Q1) from being turned on by mistake. By setting the second and third current limiters (D1 and D8), the signal processor (12) can switch from the first mode to the second mode when it senses positive voltage (+V_{CARBAT}), negative voltage (−V_{CARBAT}), or ground voltage (V_{GND}) of a vehicle battery of a vehicle power supply (232).

Furthermore, the control signal source (231) comprises a power on/off signal (POWER ON/OFF) and a switch pattern signal (SWITCH PATTERN). The power on/off signal (POWER ON/OFF) and the switch pattern signal (SWITCH PATTERN) are respectively coupled to a third active switch (Q3) or a fourth active switch (Q5) to form a coupling. An output terminal of the third active switch (Q3) or the fourth active switch (Q5) is coupled to the control input side (123) of the signal processor (12). A fourth current limiter (D4) or a fifth current limiter (D5) and two resistors ([R6, R8] or [R10, R13]) are connected in series between the control signal source (231) and the third active switch (Q3) or the fourth active switch (Q5), and pins of the two resistors ([R6, R8] or [R10, R13]) connected in series are coupled to ground. A first node (n1) between the two resistors ([R6, R8] or [R10, R13]) is coupled to a gate (G) of the third active switch (Q3) or the fourth active switch (Q5), and a source(S) of the third active switch (Q3) or the fourth active switch (Q5) is coupled to ground, and a drain (D) of the third active switch (Q3) or the fourth active switch (Q5) is coupled to the control input side (123) of the signal processor (12).

As mentioned above, the control bus (2) is also coupled to a signal processor power supply (MCUVCC). The drain (D) of the second active switch (Q1) is coupled to the control signal source (231) by the third current limiter (D8) that limits current in the reverse direction to the second current limiter (D1) and prevents the second active switch (Q1) from being turned on by mistake. The drain (D) of the third active switch (Q3) is coupled to the control signal source (231) by a sixth current limiter (D9) that limits current in the reverse direction to the fourth current limiter (D4) and prevents the third active switch (Q3) from being turned on by mistake. The drain (D) of the fourth active switch (Q5) is coupled to the control signal source (231) by a seventh current limiter (D10) that limits current in the reverse direction to the fifth current limiter (D5) and prevents the fourth active switch (Q5) from being turned on by mistake. By setting the third, sixth and seventh current limiters (D8, D9 and D10), the signal processor (12) can sense the trigger of the positive voltage (+V_{CARBAT}), the negative voltage (−V_{CARBAT}), or the ground voltage (V_{GND}) of the vehicle battery of the vehicle power supply (232), and drive the plurality of warning lights (11a~11n) to flash. The aforementioned positive voltage of the vehicle battery is +12V or +24V. The aforementioned control bus (2) is not a necessary component. Those skilled in the art can also directly couple the output terminal of the second, third or fourth active switch (Q1, Q3 or Q5) to one of the control input sides (123) of the signal processor (12). Such a simple change in the circuit should be included within the scope of protection of this invention.

Furthermore, the third, sixth and seventh current limiters (D8, D9 and D10) are configured, and the forward conduction voltage range of the third, sixth and seventh current limiters (D8, D9 and D10) is 0.1~0.799 volts (V). The restricted forward conduction voltage of the third, sixth and seventh current limiters (D8, D9 and D10) prevents the signal processor power supply (MCUVCC) from directly conducting forward to the gates (G) of the second, third and fourth active switches (Q1, Q3 and Q5). This also allows the high/low potential signal changes received by sensing pins of the signal processor (12) to trigger a 1→0 or 0→1 signal, ensuring the normal operation of the control circuit (23). Conversely, if the forward conduction voltage range of the third, sixth and seventh current limiters (D8, D9 and D10) is greater than 0.8 volts (V), it is possible that the gates (G) of the second, third and fourth active switches (Q1, Q3 and Q5) will directly conduct in the forward direction, and the control circuit (23) will not be able to operate normally.

A first current-limiting resistor (R20) is connected in series between the signal processor power supply (MCUVCC) and the drain (D) of the second active switch (Q1). A second current-limiting resistor (R21) is connected in series between the signal processor power supply (MCUVCC) and the drain (D) of the third active switch (Q3). A third current-limiting resistor (R22) is connected in series between the signal processor power supply (MCUVCC) and the drain (D) of the fourth active switch (Q5). The resistance values of the first, second and third current-limiting resistors (R20, R21 and R22) range from 1 to 100 kQ.

A first Zener diode (ZD1) is further coupled between an output terminal of the second current limiter (D1) and the gate (G) of the second active switch (Q1). A second Zener diode (ZD2) is coupled between an output terminal of the fourth current limiter (D4) and the gate (G) of the third active switch (Q3). A third Zener diode (ZD3) is coupled between an output terminal of the fifth current limiter (D5) and the gate (G) of the fourth active switch (Q5). The breakdown voltage of these first, second and third Zener diodes (ZD1, ZD2 and ZD3) is greater than or equal to the voltage supplied by the signal processor power supply (MCUVCC) to prevent the second, third or fourth active switch (Q1, Q3 or Q5) from falsely turning on. However, those skilled in this art can remove the second, fourth and fifth current limiters (D1, D4 and D5) and these first, second and third Zener diodes (ZD1, ZD2 and ZD3), retaining only the third, sixth and seventh current limiters (D8, D9 and D10) coupled between the signal processor power supply (MCUVCC) and the control signal source (231) to prevent the second, third and fourth active switches (Q1, Q3 and Q5) from being erroneously turned on. It can also achieve the effect of the signal processor (12) sensing the positive voltage (+V_{CARBAT}), the negative voltage (−V_{CARBAT}), or the ground voltage (V_{GND}) of the vehicle battery of the vehicle power supply (232) to trigger a signal to drive the plurality of warning lights (11a~11n) to flash. Any simple alteration or replacement of the aforementioned control circuit (23) shall be included within the scope of protection of this invention.

An eighth current limiter (D7) is connected in series between the first shunt resistor (R18) and the input voltage source (VIN). The input voltage source (VIN) is coupled to the positive terminal of the eighth current limiter (D7), and the negative terminal of the eighth current limiter (D7) is coupled to the first shunt resistor (R18).

The second, fourth or fifth current limiter (D1, D4 or D5) and the two resistors ([R1, R4], [R6, R8] or [R10, R13]) are connected in series between the control signal source (231) and the second, third or fourth active switch (Q1, Q3 or Q5). The two resistors ([R1, R4], [R6, R8] or [R10, R13]) are connected in series with their pins coupled to ground. Furthermore, the first node (n1) between the two resistors ([R1, R4], [R6, R8] or [R10, R13]) is coupled to the gate (G) of the second, third or fourth active switch (Q1, Q3 or Q5), the source(S) of the second, third or fourth active switch (Q1, Q3 or Q5) is coupled to ground, and the drain (D) of the second, third or fourth active switch (Q1, Q3 or Q5) is coupled to the control input side (123) of the signal processor (12) via the control bus (2). The second, fourth or fifth current limiter (D1, D4 or D5) is composed of a diode.

The aforementioned control signal source (231) comprises the power on/off signal (POWER ON/OFF), the automatic identity switching (AUTO ID), the switch pattern signal (SWITCH PATTERN) and a command signal (IND).

A data synchronization circuit (34) comprising at least one data signal source (341) is coupled to a first set of active switches (Q2, Q4 and DLQ1). An output terminal of the first set of active switches (Q2, Q4 and DLQ1) is coupled to a data input side (124) of the signal processor (12) through the data bus (3). The signal processor (12) is coupled to a signal coupling circuit (342) through the data output side (125) coupled to the data bus (3) to achieve signal and instruction synchronization between the data input side (124) and the data output side (125).

There is a second node (n2) between the data signal source (341) and a second set of active switches (Q2 and Q4). A first side of the second node (n2) is coupled to the input voltage source (VIN) through a ninth current limiter (D2) and a first resistor (R3). On a second side of the second node (n2), a tenth current limiter (D3) and two other resistors ([R7, R9]) are connected in series. The second set of active switches (Q2 and Q4) consists of a first-stage active switch (Q4) and a second-stage active switch (Q2), and pins of the two other resistors ([R7, R9]) are coupled to ground. Furthermore, a third node (n3) between the two other resistors ([R7, R9]) is coupled to a gate (G) of the first-stage active switch (Q4). Sources(S) of the first-stage active switch (Q4) and the second-stage active switch (Q2) are coupled to ground, and a drain (D) of the second-stage active switch (Q2) is coupled to the data bus (3) and the data input side (124) of the signal processor (12). A first terminal of a second resistor (R2) is coupled to the signal processor power supply (MCUVCC), and a second terminal is coupled to the drain (D) of the second-stage active switch (Q2). A drain (D) of the first-stage active switch (Q4) is coupled to a gate (G) of the second-stage active switch (Q2). A first terminal of a third resistor (R5) is coupled to the signal processor power supply (MCUVCC), and a second terminal is coupled to the drain (D) of the first-stage active switch (Q4). The ninth current limiter (D2) and the tenth current limiter (D3) are respectively composed of a diode.

The aforementioned data signal source (341) comprises a synchronization signal (SYNC) and a command signal (IND).

The aforementioned signal coupling circuit (342) comprises a signal processor power supply (MCUVCC) and a fourth resistor (R12) and a fifth resistor (R14) connected in series. Pins of the fourth resistor (R12) are coupled to the signal processor power supply (MCUVCC), and a fourth node (n4) is formed between the fourth resistor (R12) and the fifth resistor (R14) and coupled to the data bus (3) outside the data output side (125). The fifth resistor (R14) is coupled to a gate (G) of an active switch (DLQ1), and a source(S) of the active switch (DLQ1) is coupled to ground. The active switch (DLQ1) has a sixth resistor (R11) connected in series at its drain (D), and pins of the sixth resistor (R11) are coupled between the synchronization signal (SYNC) of the data signal source (341) and the second node (n2) through a signal coupling line (343).

Between the data bus (3) outside the aforementioned data output side (125) and the warning light control IC (13), there is a signal processor power supply (MCUVCC) and an eighth resistor (R15), a ninth resistor (R16) and a tenth resistor (R17) connected in series. Pins of the eighth resistor (R15) are coupled to the signal processor power supply (MCUVCC), and a fifth node (n5) coupled to the data bus (3) is formed between the eighth resistor (R15) and the ninth resistor (R16). A sixth node (n6) is formed between the ninth resistor (R16) and the tenth resistor (R17) and coupled to an enable pin of the warning light control IC (13), while pins of the tenth resistor (R17) are coupled to ground.

The aforementioned active switches (Q1, Q2, Q3, Q4, Q5, Q6 and DLQ1) are composed of an N-channel enhancement-mode metal-oxide-semiconductor field-effect transistors, and the N-channel enhancement-mode MOSFET has a Zener diode coupled between its source(S) and drain (D) to prevent electrostatic discharge (ESD). The second, third and fourth active switches (Q1, Q3 and Q5) composed of N-channel enhancement-mode MOSFET can also be replaced by a number of NPN bipolar transistors. Such embodiments that easily replace electronic components with the same function should be included within the scope of protection of this invention.

The aforementioned signal processor (12) is a built-in or external register (14) that can store the data signal (31), the clock pulse (32) and the identity information (33). The register (14) is composed of non-volatile memory (NVM).

In actual operation, the control circuit (23) of this invention for the plurality of warning lights (11a~11n) utilizes the flash activation preventive circuit (35) consisting of the first active switch (Q6), the first current limiter (D6) and the first and second shunt resistors (R18 and R19). When the warning light control circuit is activated, the activation pulse of the data bus (3) is blocked by the first current limiter (D6) and will not cause the warning light control IC (13) to turn on momentarily. The first current limiter (D6) can withstand a reverse voltage range of 100~1000 volts (V). Then, the plurality of warning lights (11a~11n) receive a start command to set the flash mode (121). The start command refers to multiple control signals provided by the control signal source (231), including the power on/off signal (POWER ON/OFF), the automatic identity switching (AUTO ID), the switch pattern signal (SWITCH PATTERN) and the command signal (IND). The multiple control signals generate a forward conduction current at the gates (G) of the second, third and fourth active switches (Q1, Q3 and Q5), and the output terminal of the second, third and fourth active switches (Q1, Q3 and Q5) transmits the multiple control signals to the control input side (123) of the signal processor (12). After receiving a control command, the signal processor (12) uses its internally stored flash mode (121) to synchronously set the identification number (122) of the plurality of warning lights (11a~11n), and sets the predetermined identification number of the plurality of warning lights (11a~11n) as the starter (4), and sets the remaining identification numbers as the receivers (5).

As described above, the warning light set as the starter (4) receives the multiple control signals through the control bus (2) and transmits the data signal (31), the clock pulse (32) and the identity information (33) through the data bus (3) outside the data output side (125), and the flash mode (121) selects one of the flash modes (the synchronous flash (1211), the interlaced flash (1212), the polling flash (1213), the recursive flash (1214), the low power mode (1215), or the sleep mode (1216)) to flash. The warning lights designated as the receivers (5) obtain the data signal (31), the clock pulse (32) and the identity information (33) through the data bus (3) and the warning light control IC (13). Furthermore, the flash mode (121) of the receivers (5) and the starter (4) flashes synchronously or asynchronously, and the starter (4) controls the receivers (5) by transmitting the data signal (31), the clock pulse (32) and the identity information (33) through the data bus (3). Furthermore, the transmission and synchronization of instructions between the starter (4) and the receivers (5) require the coupling of the signal coupling circuit (342) and the signal coupling line (343) to the data signal source (341). The synchronization signal (SYNC) and the command signal (IND) of the data signal source (341) are coupled to the data bus (3) and the data input side (124) of the signal processor (12) via the drain (D) of the second-stage active switch (Q2), so that the signals and commands between the data input side (124) and the data output side (125) are synchronized.

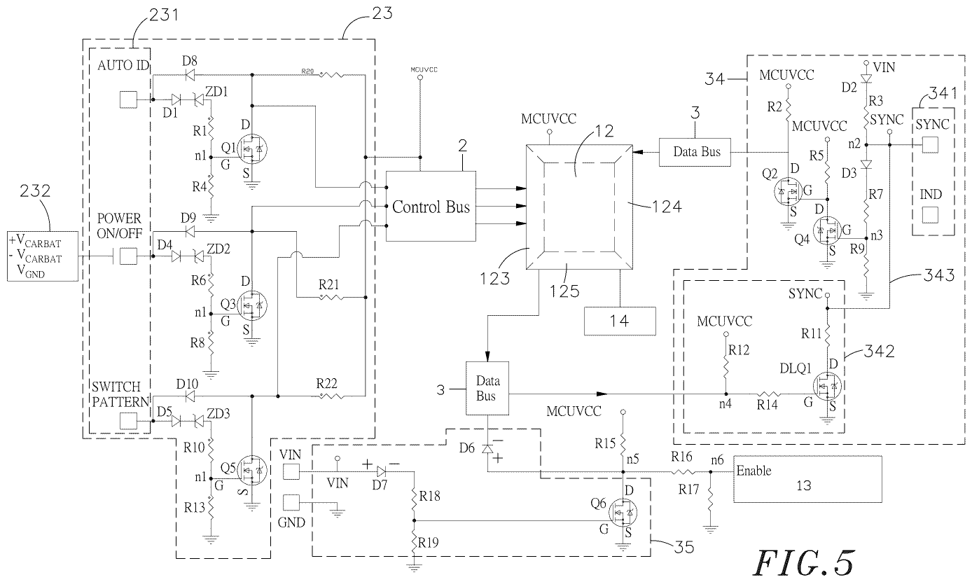

Please refer to FIGS. 3 and 5. If the control bus (2) of the starter (4) and the receivers (5) receives the change of identity command signal (22) transmitted from the switch pattern signal (SWITCH PATTERN) of the control signal source (231), it will perform changes to the flash mode (121), the identification number (122), the starter (4) and the receivers (5) to form a change of the flash mode (121) of the plurality of warning lights (11a~11n).

The main features of this invention are: By setting multiple current limiters (D1, D4, D5, D8, D9 and D10), the signal processor (12) can sense the positive voltage (+V_{CARBAT}), the negative voltage (−V_{CARBAT}), or the ground voltage (V_{GND}) of the vehicle battery of the vehicle power supply (232). These trigger signals can then drive the plurality of warning lights (11a~11n) to flash. This allows maintenance personnel unfamiliar with light device wiring and vehicle power supply assembly to perform one-by-one matching and assembly without having to identify the color of the light device wiring insulation, thus simplifying the process of installing the light device (1) in the vehicle and saving assembly time and manpower. Furthermore, since the conventional flashing mode of warning lights is a fixed input method that cannot be changed, this invention achieves the purpose of easily and quickly switching the flashing mode of warning lights by switching between the synchronous flash (1211), the interlaced flash (1212), or other flash modes (121) (e.g., the polling flash (1213), the recursive flash (1214), the low power mode (1215), or the sleep mode (1216)) through a non-polar input (the positive voltage (+V_{CARBAT}), the negative voltage (−V_{CARBAT}), or the ground voltage (V_{GND}) of the vehicle battery).

The above is only a preferred embodiment of the present invention, and does not limit the patent scope of the present invention. Therefore, all simple modifications and equivalent structural changes made by using the contents of the description and drawings of the present invention should be included in the patent scope of the present invention and should be declared.

In summary, the vehicle non-polarized input switching circuit of the present invention can achieve its effect and purpose when used, so the present invention is truly an invention with excellent practicality. In order to meet the application requirements for invention patents, we have filed an application in accordance with the law. We hope that the review committee will approve this case as soon as possible to protect the inventor's hard work in research and development. If the review committee has any questions, please feel free to write to us for instructions. The inventor will do his best to cooperate and will be grateful for the convenience.

What the invention claimed is:

1. A vehicle non-polarized input switching circuit, comprising:
a signal processor internally storing data for multiple flash modes;
a warning light control IC coupled to a plurality of warning lights installed on a vehicle and also coupled to said signal processor; and
a control circuit comprising at least one control signal source capable of performing automatic identity switching (AUTO ID), said at least one control signal source each being coupled to a second active switch (Q1), said second active switch (Q1) having an output terminal thereof coupled to a control input side of said signal processor, said at least one control signal source and said second active switch (Q1) having a second current limiter (D1) and two resistors ([R1, R4]) connected in series therebetween, said two resistors ([R1, R4]) having pins thereof coupled to ground, said two resistors ([R1, R4]) having a first node (n1) therebetween coupled to a gate (G) of said second active switch (Q1), said second active switch (Q1) having a source(S) thereof coupled to ground and having a drain (D) thereof coupled to said control input side of said signal processor, said drain (D)of said second active switch (Q1) coupled to said at least one control signal source by a third current limiter (D8) that limits current in the reverse direction to said second current limiter (D1) and prevents said second active switch (Q1) from being accidentally turned on, wherein by setting said second current limiter (D1) and said third current limiter (D8), said signal processor is capable of switching said multiple flash modes from a first mode to a second mode when sensing positive voltage (+V_{CARBAT}), negative voltage (−V_{CARBAT}), or ground voltage (V_{GND}) of a vehicle battery of a vehicle power supply.

2. The vehicle non-polarized input switching circuit as claimed in claim 1, wherein said at least one control signal source comprises a power on/off signal and a switch pattern signal, said power on/off signal and said switch pattern signal being respectively coupled to a third active switch (Q3) or a fourth active switch (Q5) to form a coupling, said third active switch (Q3) or said fourth active switch (Q5) having an output terminal thereof coupled to said control input side of said signal processor, said at least one control signal source and said third active switch (Q3) or said fourth active switch (Q5) having a fourth current limiter (D4) or a fifth current limiter (D5) and two resistors ([R6, R8] or [R10, R13]) connected in series therebetween, said two resistors ([R6, R8] or [R10, R13]) having pins thereof coupled to ground, said two resistors ([R6, R8] or [R10, R13]) having a first node (n1) therebetween coupled to a gate (G) of said third active switch (Q3) or said fourth active switch (Q5), said third active switch (Q3) or said fourth active switch (Q5) having a source(S) thereof coupled to ground and a drain (D) thereof coupled to said control input side of said signal processor.

3. The vehicle non-polarized input switching circuit as claimed in claim 1, wherein the first mode and the second mode of said multiple flash modes are selectively a synchronous flash, an interlaced flash, a polling flash, a recursive flash, a low power mode or a sleep mode.

4. The vehicle non-polarized input switching circuit as claimed in claim 1, further comprising a first current-limiting resistor (R20) connected in series between a signal processor power supply (MCUVCC) and said drain (D) of said second active switch (Q1).

5. The vehicle non-polarized input switching circuit as claimed in claim 2, further comprising a second current-limiting resistor (R21) connected in series between said signal processor power supply (MCUVCC) and said drain (D) of said third active switch (Q3), and a third current-limiting resistor (R22) connected in series between said signal processor power supply (MCUVCC) and said drain (D) of said fourth active switch (Q5).

6. The vehicle non-polarized input switching circuit as claimed in claim 1, further comprising a first Zener diode (ZD1) coupled between an output terminal of said second current limiter (D1) and said gate (G) of said second active switch (Q1), and the breakdown voltage of said first Zener diode (ZD1) is greater than or equal to the voltage provided by said signal processor power supply (MCUVCC).

7. The vehicle non-polarized input switching circuit as claimed in claim 2, further comprising a second Zener diode (ZD2) coupled between an output terminal of said fourth current limiter (D4) and said gate (G) of said third active switch (Q3) and a third Zener diode (ZD3) coupled between an output terminal of said fifth current limiter (D5) and said gate (G) of said fourth active switch (Q5), and the breakdown voltage of said second Zener diode (ZD2) and said third Zener diode (ZD3) is greater than or equal to the voltage provided by said signal processor power supply (MCUVCC).

8. The vehicle non-polarized input switching circuit as claimed in claim 1, further comprising a flash activation preventive circuit connected between said warning light control IC and a data bus, said flash activation preventive circuit comprising a first active switch (Q6), a first current limiter (D6), a first shunt resistor (R18) and a second shunt resistor (R19), said first active switch (Q6) having a gate (G) thereof coupled between one end of said first shunt resistor (R18) and one end of said second shunt resistor (R19), said first shunt resistor (R18) having an opposite end thereof coupled to an input voltage source (VIN), said second shunt resistor (R19) having an opposite end thereof coupled to ground, said first active switch (Q6) having a source(S) thereof coupled to ground, said first active switch (Q6) having a drain (D) thereof coupled to the positive (+) terminal of said first current limiter (D6), said first current limiter (D6) having the negative (−) terminal thereof coupled to said data bus; wherein when a warning light control circuit starts to conduct, said first current limiter (D6) blocks the activation pulse of said data bus to prevent said warning light control IC from turning on instantaneously.

9. The vehicle non-polarized input switching circuit as claimed in claim 1, further comprising said data bus and a data synchronization circuit coupled to said data bus, said data synchronization circuit comprising at least one data signal source, said at least one data signal source each comprising a synchronization signal and a command signal (IND) and being coupled to a first set of active switches (Q2, Q4 and DLQ1), said first set of active switches (Q2, Q4 and DLQ1) having an output terminal thereof coupled to a data input side of said signal processor via said data bus, said signal processor being coupled to a signal coupling circuit by a data output side being coupled to said data bus to achieve signal and instruction synchronization between said data input side and said data output side.

10. The vehicle non-polarized input switching circuit as claimed in claim 9, wherein said at least one data signal source and a second set of active switches (Q2 and Q4) comprise a second node (n2) therebetween, said second node (n2) having a first side thereof coupled to said input voltage source (VIN) through a ninth current limiter (D2) and a first resistor (R3) and a second side thereof connected with a tenth current limiter (D3) and two resistors ([R7, R9]) in series, said second set of active switches (Q2 and Q4) comprising a first-stage active switch (Q4) and a second-stage active switch (Q2), and said two resistors ([R7, R9]) having pins thereof coupled to ground, said two resistors ([R7, R9]) comprising a third node (n3) provided therebetween and coupled to a gate (G) of said first-stage active switch (Q4), Sources (S) of said first-stage active switch (Q4) and said second-stage active switch (Q2) being coupled to ground, a drain (D) of said second-stage active switch (Q2) being coupled to said data bus and said data input side of said signal processor, said signal processor power supply (MCUVCC) being coupled with a first terminal of a second resistor (R2), said second resistor (R2) having a second terminal thereof coupled to said drain (D) of said second-stage active switch (Q2), said first-stage active switch (Q4) having a drain (D) thereof coupled to a gate (G) of said second-stage active switch (Q2), said signal processor power supply (MCUVCC) being coupled with a first terminal of a third resistor (R5), said third resistor (R5) having a second terminal thereof coupled to said drain (D) of said first-stage active switch (Q4), said ninth current limiter (D2) and said tenth current limiter (D3) being respectively composed of a diode.

11. The vehicle non-polarized input switching circuit as claimed in claim 9, wherein said signal coupling circuit comprises a signal processor power supply (MCUVCC) and a fourth resistor (R12) and a fifth resistor (R14) connected in series, said fourth resistor (R12) having pins thereof coupled to said signal processor power supply (MCUVCC), said fourth resistor (R12) and said fifth resistor (R14) having a fourth node (n4) formed therebetween and coupled to said data bus outside said data output side, said fifth resistor (R14) being coupled to a gate (G) of an active switch (DLQ1), said active switch (DLQ1) having a source(S) thereof coupled to ground, said active switch (DLQ1) having a drain (D) thereof connected in series with a sixth resistor (R11), said sixth resistor (R11) having pins thereof coupled between said at least one data signal source and said second node (n2) through a signal coupling line.

12. The vehicle non-polarized input switching circuit as claimed in claim 1, further comprising a signal processor power supply (MCUVCC), an eighth resistor (R15), a ninth resistor (R16) and a tenth resistor (R17) connected in series between said data bus outside said data output side and said warning light control IC, said eighth resistor (R15) having pins thereof coupled to said signal processor power supply (MCUVCC), said eighth resistor (R15) and said ninth resistor (R16) having a fifth node (n5) formed therebetween and coupled to said data bus, said ninth resistor (R16) and said tenth resistor (R17) having a sixth node (n6) formed therebetween and coupled to an enable pin of said warning light control IC, said tenth resistor (R17) having pins thereof coupled to ground.
